(19) United States
(12) Patent Application Publication
(10) Pub. No.: US 2026/0321692 A1
(43) Pub. Date: Oct. 15, 2026

(54) FUEL CELL COOLING SYSTEM

(71) Applicant: HONDA MOTOR CO., LTD., Tokyo (JP)

(72) Inventors: Takuya TAMURA, Wako-shi (JP); Yusuke YAMASAKI, Wako-shi (JP)

(21) Appl. No.: 19/633,210

(22) Filed: Mar. 30, 2026

(30) Foreign Application Priority Data
Mar. 31, 2025 (JP) 2025-059399

(51) Int. Cl. H01M 8/04746; H01M 8/04029; H01M 8/0432

(52) U.S. Cl. CPC H01M 8/04768; H01M 8/04029; H01M 8/04358

(57) ABSTRACT

A fuel cell cooling system including: a circuit that includes a cooling unit capable of cooling coolant and a plurality of fuel cells provided in parallel with the cooling unit and allows coolant to flow therethrough; a plurality of temperature detectors each of which is provided for each of the plurality of fuel cells and configured to detect a temperature of the coolant for cooling the fuel cell, and a controller configured to perform duty control of the cooling unit based on a detection result from the temperature detector, wherein the controller calculates respective individual duty ratios based on the detection results from the temperature detectors and calculates a duty ratio to be applied to the cooling unit by dividing a sum of the individual duty ratios by a total number of the plurality of fuel cells, improves the accuracy of the temperature management of the fuel cells.

### REFERENCE TO RELATED APPLICATIONS

The present invention relates to and asserts priority from Japanese patent application No. 2025-059399 filed on Mar. 31, 2025, and incorporates the entirety of the contents and subject matter of all the above application herein by reference. PCT

### TECHNICAL FIELD

The present invention relates to a technique for cooling a fuel cell stack using coolant.

### BACKGROUND ART

In recent years, research and development has been conducted on fuel cells that contribute to energy efficiency, so that more people can secure access to affordable, reliable, sustainable, and advanced energy. Patent Document 1 discloses a cooling system of a fuel cell in which a plurality of fuel cell bodies are provided in parallel with respect to a radiator.

### CITATION LIST

### Patent Literature

[Patent Document 1] Japanese U.S. Pat. No. 7,400,749

### SUMMARY OF INVENTION

### Technical Problem

In a system described in Patent Document 1, a radiator is required to have a performance capable of cooling all of the plurality of fuel cell bodies. However, for example, when one of the plurality of fuel cell bodies is to be cooled, if such a radiator is operated, there is a possibility that overcooling occurs or power consumption increases. Therefore, it is desired to improve an accuracy of temperature management of the fuel cell.

The present invention has been made in view of the above requirement, and an object of the present invention is to provide a fuel cell cooling system capable of improving the accuracy of temperature management and contributing to energy efficiency.

### Solution to Problem

In order to solve the above problems, a fuel cell cooling system of the present invention includes a circuit that includes a cooling unit capable of cooling coolant and a plurality of fuel cells provided in parallel with the cooling unit and allows coolant to flow therethrough; a plurality of temperature detectors each of which is provided for each of the plurality of fuel cells and configured to detect a temperature of the coolant for cooling the fuel cell, and a controller configured to perform duty control of the cooling unit based on a detection result from the temperature detector, wherein the controller calculates respective individual duty ratios based on the detection results from the temperature detectors and calculates a duty ratio to be applied to the cooling unit by dividing a sum of the individual duty ratios by a total number of the plurality of fuel cells.

### BRIEF DESCRIPTION OF DRAWINGS

FIG. 1 is a schematic diagram showing a fuel cell cooling system according to an embodiment of the present invention.

### DESCRIPTION OF EMBODIMENTS

### Fuel Cell Cooling System

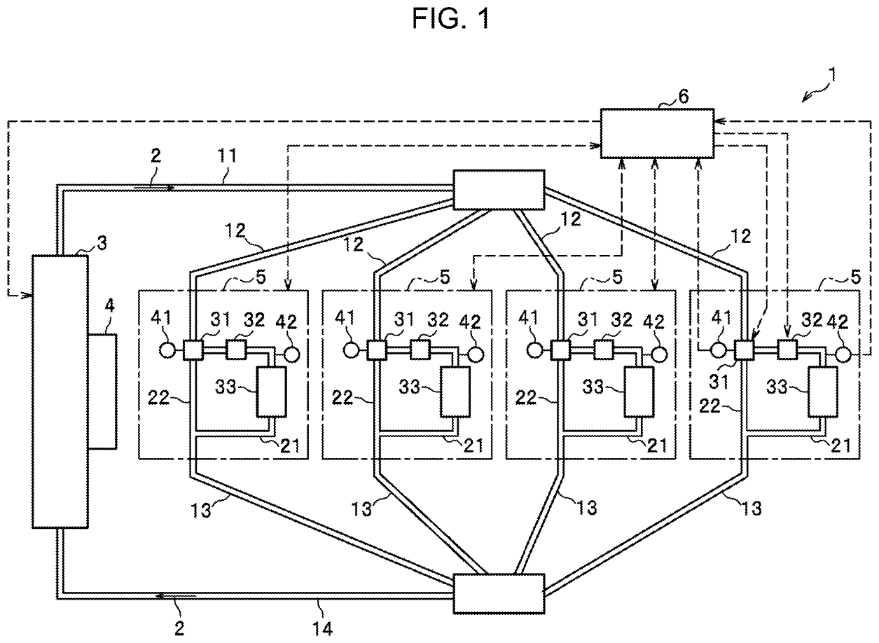

Next, an embodiment of the present invention is described in detail with reference to the drawing as appropriate. As shown in FIG. 1, a fuel cell cooling system 1 according to the embodiment of the present invention is a system that cools a plurality of fuel cell stacks 33 using coolant 2 and cools the coolant 2 using a radiator 3, the temperature of which coolant 2 is raised by the cooling of the plurality of the fuel cell stacks 33. The fuel cell cooling system 1 is applicable to, for example, a vehicle (fuel cell vehicle). The fuel cell cooling system 1 includes the radiator 3, a fan 4, a plurality of fuel cell units 5, and a controller 6. The radiator 3 and the fan 4 constitute a part of one example of the cooling unit that cools the coolant 2 under control of the controller 6.

### Radiator and Fan

The radiator 3 has a shape that makes it efficient to exchange heat between the coolant 2 flowing through the radiator 3 and outside air (for example, a shape like a plurality of fins or the like).

The fan 4 operates based on a control signal from the controller 6 and sends air to the radiator 3 by blowing or sucking to improve cooling efficiency of the coolant 2 flowing through the radiator 3.

### Fuel Cell Unit

The plurality of fuel cell units 5 generate power respectively by chemical reactions that produce water from hydrogen and oxygen. The plurality of fuel cell units 5 are arranged in parallel with and connected to one radiator 3 for flowing the coolant 2. The fuel cell unit 5 is described in detail below.

### Controller

The controller 6 is a so-called ECU (Electronic Controller) including a CPU (Central Processing Unit), a ROM (Read-Only Memory), a RAM (Random Access Memory), an input/output circuit, and the like. The controller 6 controls the fan 4 and the plurality of fuel cell units 5.

### Circuit (Coolant Flow Path)

The fuel cell cooling system 1 includes, as flow paths of the coolant 2, an upstream flow path 11, a plurality of upstream parallel flow paths 12, a plurality of downstream parallel flow paths 13, and a downstream flow path 14. These flow paths partially constitute a circuit in which the coolant 2 circulates.

An upstream end of the upstream flow path 11 is connected to a downstream end of the radiator 3 so that the coolant can flow therethrough. A downstream end of the upstream flow path 11 is connected to upstream ends of the plurality of upstream parallel flow paths 12 so that the coolant can flow therethrough.

The plurality of upstream parallel flow paths 12 each is associated with one fuel cell unit 5 and assigned in parallel with the radiator 3. An upstream end of the upstream parallel flow path 12 is connected to the downstream end of the upstream flow path 11 so that the coolant can flow therethrough. The downstream end of each of the upstream parallel flow paths 12 is connected to each of the upstream end of the fuel cell units 5 so that the coolant can flow therebetween.

The plurality of downstream parallel flow paths 13 each corresponds to one fuel cell unit 5, and is assigned in parallel with the radiator 3. Each of the upstream end of the downstream parallel flow paths 13 is connected to the downstream end of the one fuel cell unit 5 so that the coolant can flow therebetween. A downstream end of each of the plurality of downstream parallel flow paths 13 is connected to an upstream end of the downstream flow path 14 so that the coolant can flow therethrough.

The upstream end of the downstream flow path 14 is connected to the downstream ends of the plurality of downstream parallel flow paths 13 so as to allow the coolant to flow therethrough. A downstream end of the downstream flow path 14 is connected to an upstream end of the radiator 3 so as to allow the coolant to flow therethrough.

### Detailed Configuration of Fuel Cell Unit

The fuel cell unit 5 includes a main flow path 21 and a sub flow path 22 as flow paths of the coolant 2. The main flow path 21 is a flow path for cooling a fuel cell stack 33 described below. An upstream end of the main flow path 21 is connected to a downstream end of the upstream parallel flow path 12 so that the coolant can flow therethrough. A downstream end of the main flow path 21 is connected to the upstream end of one of the downstream parallel flow paths 13 so that the coolant can flow therethrough.

The sub flow path 22 is a bypass flow path of the main flow path 21. An upstream end of the sub flow path 22 is connected to a vicinity of the upstream end of the main flow path 21 so that the coolant can flow therethrough. The downstream end of the sub flow path 22 is connected to a vicinity of the downstream end of the main flow path 21 so that the coolant can flow therethrough.

The fuel cell unit 5 includes a valve 31, a pump 32, and a fuel cell stack 33 in order from the upstream to the downstream of the main flow path 21. The fuel cell unit 5 also includes an opening degree detector 41 and a temperature detector 42 as a sensor group.

### Valve

The valve 31 is provided at a branch portion of the main flow path 21 and the sub flow path 22. The valve 31 is configured to be switchable between a valve open state and a valve closed state based on a control signal from the controller 6, which states are described in the below notes.

### (Notes)

The “valve open state” is a state which opens the valve so that the coolant can flow between the upstream of the valve 31 of the main flow path 21 and at least any one of the downstream of the main flow path 21 down from the valve 31 and the sub flow path 22. In the valve open state, the valve 31 is configured to be capable of regulating a flow rate of the coolant 2 to the downstream of the valve 31 in the main flow path 21 and a flow rate of the coolant 2 to the sub flow path 22 based on a control signal from the controller 6.

The “valve closed state” is a state which blocks the coolant from flowing between the upstream of the main flow path 21 upper than the valve 31 and the downstream of the main flow path 21 lower than the valve 31 and the sub flow path 22. In a closed state, the valve 31 is configured to communicate the downstream of the valve 31 of the main flow path 21 with the sub flow path 22 so that the coolant can flow therethrough.

### Pump

The pump 32 operates based on a control signal from the controller 6 to transport the coolant 2.

### Fuel Cell Stack (Fuel Cell)

The fuel cell stack 33 generates electric power using hydrogen supplied from a hydrogen tank (not shown) and oxygen. The fuel cell stack 33 is cooled by the coolant 2 flowing through the main flow path 21.

### Flow Direction of Coolant

When the valve 31 is in the valve open state, operation of the pump 32 causes the coolant 2 to circulate around in a closed circuit from the radiator 3→the upstream flow path 11→the upstream parallel flow path 12→the main flow path 21 (or the sub flow path 22)→the downstream parallel flow path 13→the downstream flow path 14 to the radiator 3. The coolant 2 is heated by heat exchange with (heat absorption from) the fuel cell stack 33 in the main flow path 21 and is cooled by heat exchange with (heat radiation to) external air in the radiator 3.

When the valve 31 is in a closed state, the operation of the pump 32 causes the coolant 2 to circulate around in a closed circuit formed by the main flow path 21 and the sub flow path 22.

### Opening Degree Detector

The opening degree detector 41 is an opening degree sensor that detects an opening degree of the valve 31 and outputs the detection result to the controller 6. The opening degree of the valve 31 is an opening degree of the valve 31 toward the main flow path 21 (toward the fuel cell stack 33) in the above-described valve open state. As the opening degree of the valve 31 is larger, the flow rate of the coolant 2 flowing toward the main flow path 21 (the fuel cell stack 33) increases, and the flow rate of the coolant 2 flowing toward the sub flow path 22 decreases. As the opening degree of the valve 31 is smaller, the flow rate of the coolant 2 flowing toward the main flow path 21 (the fuel cell stack 33) decreases, and the flow rate of the coolant 2 flowing toward the sub flow path 22 increases. A state in which the opening degree of the valve 31 is zero corresponds to the above-described valve closed state.

### Temperature Detector

The temperature detector 42 is a temperature sensor that detects a temperature of the coolant 2 at the upstream of the fuel cell stack 33 in the main flow path 21 and outputs the detection result to the controller 6.

### Basic Control

The controller 6 controls, for each fuel cell unit 5, the valve 31 on the base of the detection result of the temperature detector 42 and controls the pump 32 on the base of the detection result of the opening degree detector 41.

When the temperature of the coolant 2 detected by the temperature detector 42 is lower than a first predetermined temperature, the controller 6 closes the valve 31 and operates the pump 32. In this state, the operation of the pump 32 causes the coolant 2 to circulate around in the closed circuit in the fuel cell unit 5, which is formed by the main flow path 21 and the sub flow path 22. The coolant 2 increases in temperature by exchanging heat with the fuel cell stack 33 (absorbing heat, cooling the fuel cell stack 33) in the main flow path 21.

When the temperature of the coolant 2 detected by the temperature detector 42 is equal to or higher than the first predetermined temperature, the controller 6 opens the valve 31 and operates the pump 32. In this state, the operation of the pump 32 causes the coolant 2 to circulate around in the closed circuit from the radiator 3→the upstream flow path 11→the upstream parallel flow path 12→the main flow path 21 (or the sub flow path 22)→the downstream parallel flow path 13→the downstream flow path 14 to the radiator 3. The coolant 2 is heated by exchanging heat with the fuel cell stack 33 (absorbing heat, cooling the fuel cell stack 33) in the main flow path 21 and is cooled by exchanging heat with (radiating heat to) the external air in the radiator 3.

### Opening Degree Follow Control

In the present embodiment, the controller 6 uses the maximum opening degree among the opening degrees detected by the opening degree detectors 41 of the plurality of fuel cell units 5 to control the valves 31 of the fuel cell units 5 other than the fuel cell unit 5 whose opening degree is the maximum so that their opening degrees are equal to the maximum. According to such control, the pressure loss of the coolant 2 in the plurality of fuel cell units 5 can be matched, which can suppress the opening/closing operation of the valve 31 having the maximum opening degree from causing occurrence of pulsation of the coolant 2 in the other fuel cell units 5.

More specifically, the controller 6 calculates the temperature difference between the temperature of the coolant 2 detected by the temperature detector 42 of the fuel cell unit 5 at the maximum opening degree and the temperature of the coolant 2 detected by the temperature detector 42 of the fuel cell unit 5 at an opening degree other than the maximum opening degree. When the temperature difference (absolute value thereof) is less than a predetermined value, the controller 6 controls the opening degree of the valve 31 for each fuel cell unit 5 as described above.

When the temperature difference (absolute value thereof) is equal to or greater than the predetermined value, the controller 6 controls the valve 31 of the corresponding fuel cell unit 5 to have the maximum opening degree, and then controls the valves 31 to have a valve opening degree on the basis of the temperature of the coolant 2 detected by the temperature detector 42 of the corresponding fuel cell unit 5 (returns to a normal control). According to such control, it is possible to suppress the flow of the cooled coolant 2 to the fuel cell unit 5 that does not need to be cooled while suppressing the pulsation of the coolant 2.

The controller 6 controls the valve 31 such that a valve closing speed of the valve 31 when the valve 31 is returned to under the normal control is faster than a valve opening speed of the valve 31 on the control of making the valve 31 to the maximum opening degree. According to such control, it is possible to suppress the pulsation of the coolant 2 when the valve 31 is returned to under the normal control.

The controller 6 controls the valve closing speed of the valve 31 when returning the valve 31 to the normal control, on the basis of the temperature of the coolant 2 detected by the temperature detector 42 of the corresponding fuel cell unit 5. Specifically, the controller 6 increases the valve closing speed of the valve 31 as the temperature of the coolant 2 is lower, and decreases the valve closing speed of the valve 31 as the temperature of the coolant 2 is higher. Such control allows suppressing excessive cooling of the fuel cell stack 33 while suppressing unnecessary power consumption and the like.

In addition to the above-described opening degree follow control, the controller 6 may be configured to regulate, on a basis of the maximum opening degree, an operation amount (for example, a rotation speed) of the pump 32 of the fuel cell unit 5 on which the above-described opening degree follow control is executed.

The controller 6 may be configured to execute the opening degree follow control for the fuel cell unit 5 whose difference in its opening degree from the maximum opening degree is less than a predetermined opening degree difference, and not to execute the opening degree follow control for the fuel cell unit 5 whose difference in its opening degree from the maximum opening degree is equal to or greater than the predetermined opening degree difference. Such control allows suitably suppressing cooling of the fuel cell stack 33 that does not need to be cooled.

In addition, the controller 6 may be configured to have a function of diagnosing abnormalities of the plurality of fuel cell units 5. In this case, the controller 6 limits an amount of power generation of the fuel cell stack 33 in the fuel cell unit 5 diagnosed as abnormal, and sets the opening degree of the valve 31 to an opening degree at which the coolant pressure loss is minimized (for example, an opening degree that is intermediate between the maximum opening degree and the minimum opening degree). Such control is able to fix the coolant pressure loss of the fuel cell unit 5 diagnosed as abnormal to the minimum and to suppress an influence (pulsation influence to the coolant 2) on the other normal fuel cell units 5 due to the coolant pressure loss of the fuel cell unit 5 diagnosed as abnormal.

### Fan Control

In the present embodiment, the function of the fan 4 is set to a specification that enables the coolant 2 to be cooled even when the temperature of the coolant 2 becomes very high in all of the plurality of fuel cell units 5. The controller 6 stops the fan 4 when all of the plurality of fuel cell units 5 do not require cooling (operation of the fan 4) by the cooling unit, and operates the fan 4 when at least one of the plurality of fuel cell units 5 requires cooling (operation of the fan 4) by the cooling unit. Such control allows suppressing overcooling of the coolant 2 and unnecessary power consumption as well as suitably cooling the coolant 2.

In the present embodiment, when the detection result of the temperature detector 42 is less than the first predetermined temperature, the controller 6 determines that the corresponding fuel cell unit 5 does not require the operation of the fan 4. When the detection result of the temperature detector 42 is equal to or higher than the first predetermined temperature, the controller 6 determines that the corresponding fuel cell unit 5 requires the operation of the fan 4. It means that the controller 6 stops the fan 4 when all of the detection results of the temperature detectors 42 in the plurality of fuel cell units 5 are less than the first predetermined temperature. Further, the controller 6 operates the fan 4 when at least one of the detection results of the temperature detectors 42 in the plurality of fuel cell units 5 is equal to or higher than the first predetermined temperature.

The controller 6 may be configured to stop the fan 4 when only one of the fuel cell units 5 requires the operation of the fan 4, and to operate the fan 4 when at least two of the fuel cell units 5 require the operation of the fan 4. Such control makes it possible to suppress a decrease in operation efficiency due to overcooling of the fuel cell stack 33.

The controller 6 calculates the individual duty ratio of each fuel cell unit 5 that needs to be cooled by the fan 4 on a basis of at least one of the detection results from the opening degree detector 41 and the temperature detector 42 for each fuel cell unit 5 that requires the operation of the fan 4.

When using the detection result of the opening degree detector 41, the controller 6 calculates the individual duty ratio such that it is larger as the opening degree of the valve 31 detected by the opening degree detector 41 is larger. In other words, the controller 6 calculates the individual duty ratio such that it becomes smaller as the opening degree of the valve 31 detected by the opening degree detector 41 is smaller. Note that the detection result of the opening degree detector 41 can be said to be a parameter regarding the temperature of the coolant 2 similarly to the detection result of the temperature detector 42, because the opening degree of the valve 31 is set on the basis of the temperature of the coolant 2 detected by the temperature detector 42.

When using the detection result of the temperature detector 42, the controller 6 calculates the individual duty ratio such that the individual duty ratio is larger as the temperature of the coolant 2 detected by the temperature detector 42 is higher. In other words, the controller 6 calculates the individual duty ratio such that it is smaller as the temperature of the coolant 2 detected by the temperature detector 42 is lower. Here, it can be said that the controller 6 calculates the individual duty ratio as zero for the fuel cell unit 5 that does not require the operation of the fan 4.

The controller 6 calculates a duty ratio actually applied to the fan 4 using the following equation (1).

[duty ratio]=[sum of individual duty ratios]/[total number of fuel cell units 5] Equation (1)

In the example shown in FIG. 1, the total number of the fuel cell units 5 is four. The “sum of individual duty ratios” is the sum of the individual duty ratios each of which is calculated as cooling by the cooling unit is needed, and is obtained by adding the individual duty ratios only of the fuel cell units 5 (fuel cell stacks 33) that need to be cooled. The controller 6 performs duty control of the fan 4 on the basis of the calculated duty ratio. Such duty control can be performed by controlling the rotation speed of the fan 4, a ratio of the operating time to a pausing time, and the like. Such control allows the temperature management of the plurality of fuel cell stacks 33 to be performed with a small number of radiators 3 (and fans 4). Further, such control allows improving the accuracy of the temperature management of the fuel cell stacks 33.

In the present embodiment, the controller 6 calculates the duty ratio to be actually applied to the fan 4 using Equation (1), when the maximum value among the temperatures of the coolant 2 detected by the temperature detectors 42 of the plurality of fuel cell units 5 is less than the second predetermined temperature (the second predetermined temperature is greater than the first predetermined temperature). When the maximum value of the temperature of the coolant 2 detected by the temperature detectors 42 of one fuel cell unit 5 is equal to or higher than the second predetermined temperature, the controller 6 calculates the duty ratio to be actually applied to the fan 4 using the following equation (2) even when the number of the fuel cell units 5 needing the operation of the fan 4 is only one.

[duty ratio]=[maximum value of individual duty ratio]*[number of fuel cell units 5 needing operation of fan 4]/[total number of fuel cell units 5] Equation (2)

In Equation (2), the duty ratio is calculated using only the maximum value among the individual duty ratios without using the individual duty ratios other than the maximum value. Such control allows suitably cooling the high-temperature coolant 2, and protecting the overheated fuel cell stack 33 to improve the durability of the fuel cell stack 33.

In addition, when the maximum values among the temperatures of the coolant 2 detected by the temperature detectors 42 of the plurality of fuel cell units 5 are equal to or higher than the second predetermined temperature, the controller 6 may be configured to calculate the duty ratio to be actually applied to the fan 4 using the following equation (3).

[Duty ratio]=[Maximum value among individual duty ratios] Expression (3)

The controller 6 may be configured to detect an abnormality of the fuel cell control system 1 and set the duty ratio of the fan 4 to a duty ratio for abnormality (a predetermined fixed value) when detecting an abnormality. Here, the controller 6 may be configured to set the duty ratio of the fan 4 to a fixed value when an output of the fuel cell unit 5 in which an abnormality is detected is limited and the opening degree of the valve 31 in the fuel cell unit 5 in which an abnormality is detected is equal to or greater than a predetermined opening degree. In addition, when the output of the fuel cell unit 5 in which the abnormality is detected is not limited, or when the opening degree of the valve 31 in the fuel cell unit 5 in which the abnormality is detected is less than the predetermined opening degree, the controller 6 may be configured to stop the fuel cell control system 1 and notify the abnormality and the stopping by an image and/or a sound through a display unit and/or a sound output unit.

The duty ratio actually applied to the fan 4 may be set in a stepwise manner. For example, when it is assumed that A and a are constants and n is an integer equal to or greater than 0, the controller 6 may be configured to adopt “A+n*a” as the duty ratio when the duty ratio calculated using any one of the above Equations (1), (2), and (3) is equal to or greater than “A+n*a” and less than “A+(n+1)*a”.

The fuel cell system 1 according to the embodiment of the present invention includes a circuit allowing the coolant to flow therethrough, the circuit including a cooling unit (radiator 3 and fan 4) capable of cooling the coolant 2 and a plurality of fuel cells (fuel cell stack 33) assigned in parallel with the cooling unit; a plurality of temperature detectors 42 respectively provided for the plurality of fuel cells and configured to detect a temperature of the coolant for cooling the fuel cells; and a controller 6 configured to perform duty control of the cooling unit on the basis of detection results of the temperature detectors 42, wherein the controller 6 calculates individual duty ratios on the basis of the detection results from the temperature detectors and calculates a duty ratio to be applied to the cooling unit by dividing a sum of the individual duty ratios by a total number of the plurality of fuel cells.

Therefore, the fuel cell cooling system 1 is able to improve the accuracy of the temperature management of the fuel cells.

The controller 6 calculates the duty ratio when the cooling unit needs to cool two or more of the fuel cells.

Therefore, the fuel cell cooling system 1 allows suppressing a deterioration in operation efficiency due to overcooling of the fuel cells.

The controller 6 calculates the duty ratio when the temperature of the coolant 2 detected by one of the temperature detectors 42 is equal to or higher than a predetermined temperature (the second predetermined temperature).

Therefore, the fuel cell cooling system 1 allows improvement of durability of the fuel cell stack by protecting the overheated fuel cell.

When the temperature of the coolant 2 detected by one of the temperature detectors 42 is equal to or higher than the predetermined temperature, the controller 6 calculates the duty ratio on the basis of only the individual duty ratio based on the temperature of the coolant 2 equal to or higher than the predetermined temperature.

Therefore, the fuel cell cooling system 1 is able to suitably protect the overheated fuel cell to improve the durability of the fuel cell stack.

Although the embodiment of the present invention is described as above, the present invention is not limited to the above embodiment and can be appropriately modified without departing from the gist of the present invention. For example, the fuel cell cooling system 1 of the present invention is applicable to a fuel cell other than a fuel cell for a fuel cell vehicle. The cooling unit is not limited to the radiator 3 and the fan 4.

### REFERENCE SIGNS LIST

1: fuel cell cooling system
2: coolant
3: radiator (cooling unit)
4: fan (cooling unit)
5: fuel cell unit
6: controller
31: valve
32: pump
33: fuel cell stack (fuel cell)

1. A fuel cell cooling system comprising:
a circuit that includes a cooling unit capable of cooling coolant and a plurality of fuel cells provided in parallel with the cooling unit and allows coolant to flow therethrough;
a plurality of temperature detectors each of which is provided for each of the plurality of fuel cells and configured to detect a temperature of the coolant for cooling the fuel cell, and
a controller configured to perform duty control of the cooling unit based on a detection result from the temperature detector, wherein
the controller calculates respective individual duty ratios based on the detection results from the temperature detectors and calculates a duty ratio to be applied to the cooling unit by dividing a sum of the individual duty ratios by a total number of the plurality of fuel cells.

2. The fuel cell cooling system according to claim 1, wherein
the controller calculates the duty ratio when the cooling unit needs to cool two or more of the fuel cells.

3. The fuel cell cooling system according to claim 1, wherein
the controller calculates the duty ratio, when the temperature of the coolant detected by one of the temperature detectors is equal to or higher than a predetermined temperature.

4. The fuel cell cooling system according to claim 3, wherein
the controller calculates the duty ratio based on only an individual duty ratio based on the temperature of the coolant equal to or higher than the predetermined temperature, when the temperature of the coolant detected by the one of the temperature detectors is equal to or higher than the predetermined temperature.
